(19) United States
(12) Patent Application Publication
(10) Pub. No.: US 2006/0167844 A1
(43) Pub. Date: Jul. 27, 2006

(54) Diagnostics portal

(75) Inventors: Nelamangala Krishnaswamy Srinivas, Sammamish, WA (US); Alan Bruce Back, Redmond, WA (US); Reid Alan Lowery, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/042,192

(22) Filed: Jan. 24, 2005

(51) Int. Cl. G06F 7/00

(52) U.S. Cl. 707/3

(57) ABSTRACT

An information portal for aiding support professionals, such as computer support professionals, in diagnosing and correcting problems is disclosed. A plurality of high quality information resources in a plurality of formats are organized by topics and subtopics familiar to the professionals to reduce the amount of searching required to access the information resources. Requests for new information resources are supported by the portal as are requests for collaboration with the subject expert. New information resources are submitted to the portal through a software assisted quality control process to ensure the quality, reliability, and timeliness of the resource information.

### FIELD OF THE INVENTION

The present invention relates to diagnosing and correcting problems, more particularly, to an information portal that provides aid in diagnosing and correcting problems.

### BACKGROUND OF THE INVENTION

While the invention was designed for use in diagnosing and correcting problems in computer systems, such as computer operating systems, for example, and is described in such an environment, it is to be understood that the invention may also find use in the diagnosis and correction or problems in other areas.

When trained computer technical support personnel (“computer support professional”) are asked to diagnose and correct a problem in a computer system, the amount of information the computer support professionals must search through while solving the problem is frequently overwhelming. It is often the case that truly useful information is obscured by large amounts of irrelevant or only vaguely related information. Even when relevant information is discovered, it may be of poor quality and, thus, may make it difficult for a computer support professional to develop a workable solution to a problem in a computer system. This lack of easily accessible, high quality information can drastically increase the amount of time the computer support professional spends when solving a problem or, in some instances, prevent the professional from solving the problem at all. Thus, the capacity of the computer support professional to technically support a given computer system is reduced.

The problem of providing easily accessible, high quality information about a subject is often difficult, particularly if the subject is computer system problems. While there are many ways to access information, it is often difficult to easily access a particular piece of information. In the past, a computer support professional in the midst of solving a computer system problem is often required to search through many network-based, electronic, and/or printed information resources in order to find the information which is required to solve the problem at hand.

A less obvious difficulty, namely, the indeterminate quality of information resources, may cause a computer support professional to waste time and effort attempting to apply information that is incorrect, incomplete, and/or misleading. The effect of the indeterminate quality of information resources often goes undetected because, in the past, computer support professionals have often been unaware of the quality of the information they have discovered. Vague clues in the information itself and/or the word of a coworker are often the only guides computer support professionals have when deciding which information to use and which information not to use when solving a computer system problem.

Another difficulty, namely, assessing the applicability of information, also confronts computer support professionals intent on solving a computer system problem. As a computer support professional gains experience, the professional will eventually learn to recognize if discovered information applies to the types of problems he or she is attempting to solve. However, this knowledge is gained at the cost of much wasted time and effort. Further previously acquired knowledge often becomes lost due to lack of constant use unless well indexed or categorized.

The causes of the aforementioned difficulties, in effect, result from a failure to provide a centralized, well indexed, reliable source of the information necessary for computer support personnel to efficiently perform their jobs.

Technical information stored on computer servers can be accessed via the Internet or a corporate intranet by using a Web browser, or by downloading files directly. Technical information is also stored for direct access on compact discs (CD), digital versatile discs (DVD), Flash memory devices, and magnetic tape. Printed media, like books, manuals, and periodicals are also still in wide use by computer support professionals. In addition to “hard copy” books, manuals, and periodicals are widely available in computer-accessible formats including, but not limited to, Web pages, CD, and DVD. Computer support professionals must not only acquire the media on which the information is stored, but often must own, or have access to, devices that allow them to access the information.

The specific content formats for electronically archived information are too numerous to list. Content format categories include: text; digital images and photos; digital sound, music and speech; 2D and 3D animation; and video. Even if a computer support professional manages to gain access to the physical medium on which the desired information is stored, the computer support professional must have the appropriate devices and software to read or play the computer files containing the information.

The many information presentation formats available to the trained computer support professional include, but are not limited to, source code, procedural flow charts, XML schemas, class diagrams, standard Universal Modeling Language (UML) diagrams, and presentation formats peculiar to a specific company or product. Even if the computer file containing the appropriate information is discovered, the information may not be easily recognizable if the computer support professional is not familiar with the information presentation format.

Technical information is available from many resources including, but not limited to, coworkers, in-house experts, experts external to the organization, product designers, companies, professional organizations, and open source organizations. The levels of reliability and timeliness of an information resource will vary depending on the type of information available from the resource, who created the resource, the purpose for which the resource was created, when the resource was created and most recently updated, etc. If the level of reliability or timeliness of an information resource falls below an acceptable level, applying the resource information may be inappropriate even if the information is relevant. For example, the resource information may lead a computer support professional to believe that the information provides the key to a workable solution. However, if the information is unreliable or untimely, the information may not actually result in a workable solution.

The aforementioned difficulties require a solution. The solution should provide a centralized, easy to use way to identify and extract the information needed to diagnose and solve a particular problem from a variety of information resources. The solution should also ensure the reliability and timeliness of the information contained in information resources.

### SUMMARY OF THE INVENTION

In accordance with the present invention, a system, and method, including computer-readable medium, that makes available to professionals that support a particular area of endeavor, such as computer support professionals supporting computer systems, a plurality of information resources containing high quality, reliable support information are provided. Embodiments of the present invention reduce the amount of searching required by prior art ad hoc solutions when a support professional requires information to diagnose and solve a particular problem. More specifically, information resources in multiple varieties of storage and access media, in multiple content formats, and in multiple presentation formats are supplied by an information portal, i.e., a portal that includes or has access to an information resource store. Preferably, the information portal provides a user interface that enables a user, such as a computer support professional, to request new information resources if the information resources store does not contain the required information. Also, preferably, the user interface enables a user to request collaboration with an expert in a particular problem area (“subject expert”) if the user is unable to solve the computer support problem using the information resources. Finally, preferably, the user interface enables subject experts to submit one or more information resources for inclusion in the information resources store through a software supported process that ensures the reliability and timeliness of the information.

In accordance with one aspect of the invention, the information portal is made available to users of computing devices connected to a network such as the Internet.

In accordance with another aspect of the invention, preferably, the information resources are organized such that the resources are searchable using topics and subtopics familiar to computer support professionals. Examples of topics familiar to computer support professionals that support a computer operating system, such as the Microsoft® Windows operating system, include, but are not limited to, Administrative Tools, Clustering, Debugging, Directory Services, Distributed Systems, File Systems, Networking, Performance, Printing, Storage Area Networks (SAN), Storage Services, Video Training, and Virus-System Recovery.

In accordance with yet another aspect of the invention, the information resources are provided in a plurality of forms and formats, including but not limited to, technical articles; white papers; source code; various software tools which may be used to analyze and/or correct problems in a computer system; network links to other information resources; troubleshooters, which are software applications to guide users through the process of analyzing and correcting various computer system problems; and videos, which present various computer system concepts and/or demonstrate the use of various software tools.

In accordance with yet another aspect of the invention, if available information resources are insufficient to solve a computer system problem, preferably, embodiments of the invention allows users to describe the computer system problem and request information resources not yet available in the information resource store and/or an opportunity to collaborate with one or more subject experts. Preferably, a request to collaborate includes data about the computer system problem sufficient to give the subject expert or experts background, context, and/or clues regarding the problem adequate for the expert or experts to solve the problem. Preferably, chosen subject experts are persons who are both well versed in the subject area of the computer problem and familiar with the contents of the information resource store, including how the store is organized, especially with relation to the expert's subject area.

In accordance with yet another aspect of the invention, preferably, embodiments of the invention that allow subject experts to submit information resources the experts have created or gathered for inclusion in the information resource store, provide for the submitted information resource to be reviewed prior to inclusion. This ensures that the submitted information resource is not redundant, and is useful and correct.

As will be readily appreciated from the foregoing summary, embodiments of the invention provide an information resource store and other features that are ideally suited to improve the ability of support professionals, such as computer support professionals to diagnose and provide solutions to problems.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating the major components of an exemplary network environment suitable for implementing an information (diagnostic) portal;

FIG. 2 is a pictorial diagram illustrating how information accessed via the information portal illustrated in FIG. 1 is organized;

FIG. 3 is a flow diagram showing the top level navigation paths through an information portal;

FIG. 4 is a flow diagram showing the navigation paths through an information portal when a request for collaboration or resources is submitted;

FIG. 5 is a flow diagram showing the navigation paths through an information portal when new information is submitted for review;

FIG. 6 is an exemplary information portal home page;

FIG. 7 is an exemplary page showing topics which may be available via an information portal;

FIG. 8 is an exemplary page which may be used to submit new information to an information portal for review; and

FIG. 9 is an exemplary page listing the top level services available in an exemplary information portal.

### DETAILED DESCRIPTION

Embodiments of the invention provide a computer system and a method, including a computer-readable medium, that support and enable an information (diagnostic) portal. While the information portal is ideally suited for use by computer support professionals and is described in an environment where computer support professionals provide solutions to computer problems. Embodiments of the invention may find use in other environments. Thus, the invention should not be construed as limited to the specifically described environment of use. The exemplary embodiment of an information portal described herein presents a plurality of user interface pages that enable searching an information resources store. The information resources store contains information organized according to topics and subtopics familiar to users, e.g., computer support professionals, that enable: (a) access to informational items such as, but not limited to, articles, white papers, source code, software tools, network links, troubleshooters, and videos; (b) requesting additional information and/or collaboration with one or more subject exerts; and (c) subject experts to submit additional information for review for subsequent inclusion in the information resources store accessed by the information portal.

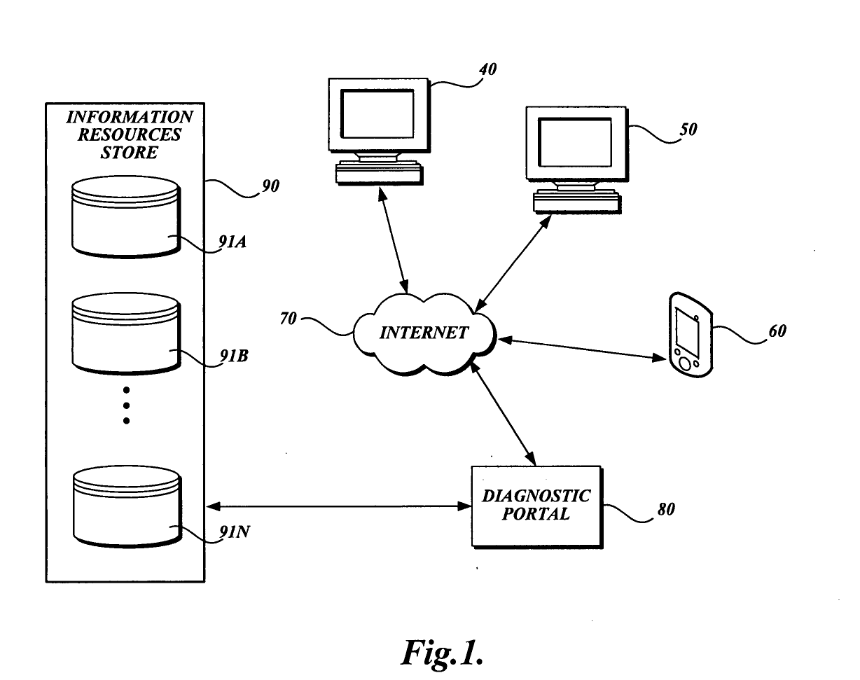

FIG. 1 and the following discussion is intended to provide a description of an exemplary network environment in which the invention may operate. The description, which includes a brief, general description of some of the major components that may be included in the environment should be construed as exemplary, not limiting. FIG. 1 includes an information (diagnostic) portal 80 connected to other computing devices via the Internet 70. The diagnostic portal 80 is connected or coupled to one or more support information databases 91a, 91b, . . . 91n, which make up an information resources store 90. While shown as connected or coupled directly to the diagnostic portal, the information resources store, i.e., the support information databases 90, alternatively, the information resources store could be coupled to the diagnostic portal via a network including the Internet. Further, while being depicted as separate, if desired, the diagnostic portal 80 and the information resources store 90 can be combined in a unitary device. The other computing devices illustrated in FIG. 1 include, but are not limited to, personal computers 40 and 50, including laptop and tablet computers, and personal digital assistants (PDA) 60. Other possible computing devices not pictured are cellular telephones and set top boxes.

Other possible computing devices include computing systems, rather than more discrete devices. That is, while the computing devices include a personal computer usable as a stand alone computer, they also include distributed computing environments where complementary tasks are performed by remote computing devices linked together through a communication network. Thus, those skilled in the art and others will appreciate that the invention can be practiced with many computing system configurations, including multi processor systems, mini computers, mainframe computers, and the like.

While the invention is most easily understood in terms of application programs that run on an operating system in conjunction with a personal computer, those skilled in the art will recognize that embodiments of the invention will most likely be implemented in combination with other program modules. Generally, program modules include routines, programs, components, data structures, etc., that perform particular tasks or implement particular abstract data types.

In its most basic configuration, an exemplary computing device typically includes a processing unit and system memory. Depending on the exact configuration and type of computing device, system memory may include volatile memory (such as RAM), nonvolatile memory (such as ROM), flash memory, etc., or some combination of the two. Additionally, the computing device may include mass storage (removable storage and/or nonremovable storage) such as magnetic, or optical disc, or tape. Similarly, computing device may also include one or more input device(s), such as a mouse and keyboard, and/or output device(s), such as a display. A computing device may further include network connection(s) to other devices, such as computers, networks, servers, etc., using either wired or wireless media. Because all of these devices are well known in the art, they are not discussed further here.

Computing devices typically include at least some form of computer readable medium, computer readable media can be any available media that can be accessed by computing device. By way of example, and not limitation, computer readable media may comprise computer storage media and communication media. As noted above, computer storage media includes volatile and nonvolatile, removable and nonremovable computer readable instructions, data structures, program modules, or other data. Computer storage media includes, but is not limited to, RAM, ROM, EEPROM, flash memory or other memory technology, CD-ROM, digital versatile discs (DVD), or other optical storage, magnetic cassettes, magnetic tape, magnetic disk storage, or other magnetic storage devices, or any other medium which can be used to store desired information accessible by a computing device. Communication media typically comprise computer readable instructions, data structures, program modules, or other data in a modulated data signal such as a carrier wave or other transport mechanism and includes any information delivery media. The term “modulated data signal” means a signal that has one or more of its characteristics set or changed in such a manner as to include information in the signal. By way of example, and not limitation, communication media includes wired media, such as a wired network or direct wired connection, and wireless media, such acoustic, RF, infrared, and other wireless media. Combinations of any of the above should also be included in the scope of computer readable media.

In addition to the aforementioned physical components, computing systems supported by a computing device may also contain software components, such as component drivers for the peripheral components.

Returning to FIG. 1, the diagnostic portal 80 provides a portal to the support information databases included in the information resources store. The information resources store stores a variety of information usable to users accessing the information resources store via the diagnostic portal 80. As will be better understood from the following discussion, in the case of an embodiment of the invention employed by computer support professionals, the information resources store 90 stores information usable by such professionals to solve computer problems. Computer problems cover problems associated with any type of computing device or system including, but not limited to, the computing devices and systems described above. The information stored in the information resources store includes a variety of types of information organized in a logical manner. The diagnostic portal 80 provides a user interface to the stored information. The types of information include but are not limited to technical articles; white papers; source code; various software tools which may be used to analyze and/or correct problems in a computer system; network links to other information resources; troubleshooters, which are software applications to guide users through the process of analyzing and correction various computer system problems; and videos, which present various computer system concepts and/or demonstrate the use of various software tools.

The information is organized using topics and subtopics familiar to computer support professionals. Examples of topics include, but are not limited to, Administrative Tools, Clustering, Debugging, Directory Services, Distributed Systems, File Systems, Networking, Performance, Printing, Storage Area Networks (SAN), Storage Services, Video Training, and Virus-System Recovery.

The diagnostic portal also provides a user interface that enables a user, such as a computer support professional, to request new information resources if the information resources store does not contain the required information. Preferably, the user interface also enables a user to request collaboration with an expert in a particular problem area (“subject expert”) if the user is unable to solve the computer support problem using the information resources. Finally, preferably, the user interface enables subject experts to submit one or more information resources for inclusion in the information resources store through a software supported process that ensures the reliability and timeliness of the information.

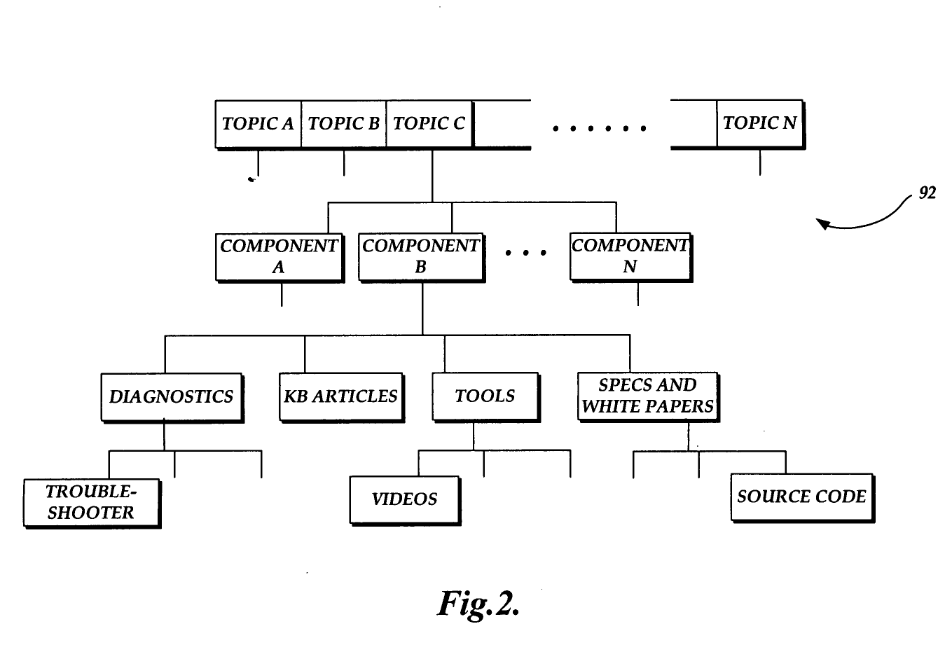

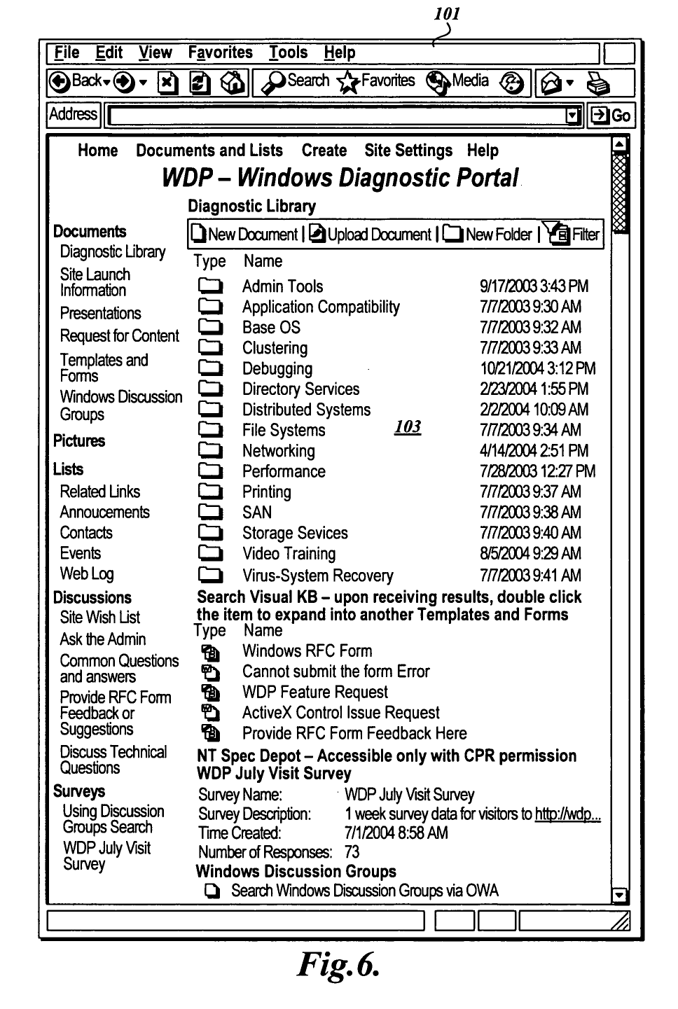

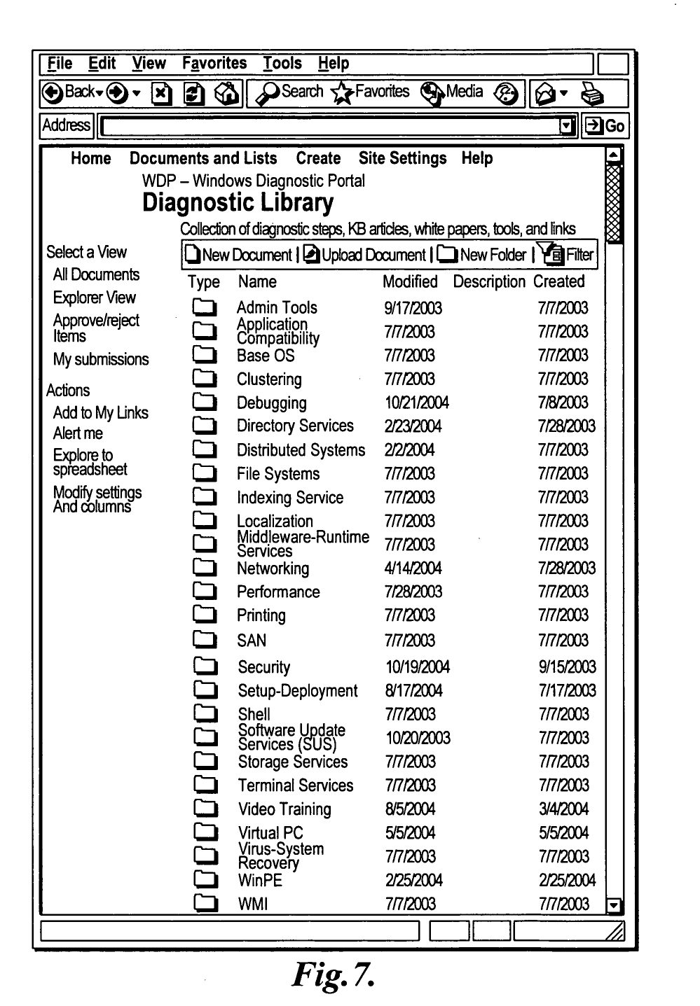

While the information stored in the information resources store can be indexed in various ways, preferably, the information is stored in an easy to use hierarchical manner, an example of which that is ideally suited to computer support professionals is shown in FIG. 2. More specifically, FIG. 2 illustrates a hierarchical tree 92 wherein the highest level includes list of topics—Topic A, Topic B, Topic C, . . . Topic N—examples of which are set forth above. As shown in FIG. 6 and 7 and described below, the list of topics is displayed in one or more user interface pages. Each topic is, in turn, linked to a page that lists subtopics, which in the case of computer support professionals, are defined as components, generally illustrated in FIG. 2 as Component A, Component B, . . . Component N for Topic C. In order to avoid unduly complicating FIG. 2, the subtopics or components of Topic A, Topic B, . . . Topic N are not illustrated. Each subtopic or component is, in turn, linked to a page that lists a number of subsubtopics. Preferably, the number of subsubtopics is the same for each subtopic. In the computer support professional tree illustrated in FIG. 2, the subsubtopics are identified as Diagnostics, KB Articles, Tools and Specs (for specifications) and White Papers. Each subsubtopic is linked to one or more low level pages, examples of which are shown in FIG. 2 i.e., Troubleshooter for Diagnostics, Videos for Tools and Source Code for Specs and White Papers. Obviously, these pages, i.e., Trouble-shooter, Videos and Source Code, can be linked to still lower level pages.

Troubleshooter denotes a link to software that enables the testing, examination, analysis, diagnosis, and/or repair of one or more software components of a computer, computing device, or computing system, or the software driver components which provide the software interface to peripheral devices contained within or connected to a computer, computing device, or computing system, generally herein referred to as a computer problem. More specifically, Troubleshooter provides a link to text files, pictorial files, or software applications which guide the user through a series of interconnected procedures which may eventually lead to a solution of a particular computer system problem. Troubleshooters may include other communication media such as, but not limited to, audio or video and may be comprised of a combination of text, pictures, software programming, and other communication media. The use of text, pictures, and software programming in troubleshooters is exemplary and should not be construed as limiting.

Source Code is a link to a source code list that may be helpful to resolving a “computer problem” and Video is a link to a video that displays a solution to a computer problem. That is, video refers to video clips that present computer system concepts; procedures involving various software tools; and/or procedures for testing, analyzing, diagnosing, and solving computer system problems; or other information relating to the support of computer systems.

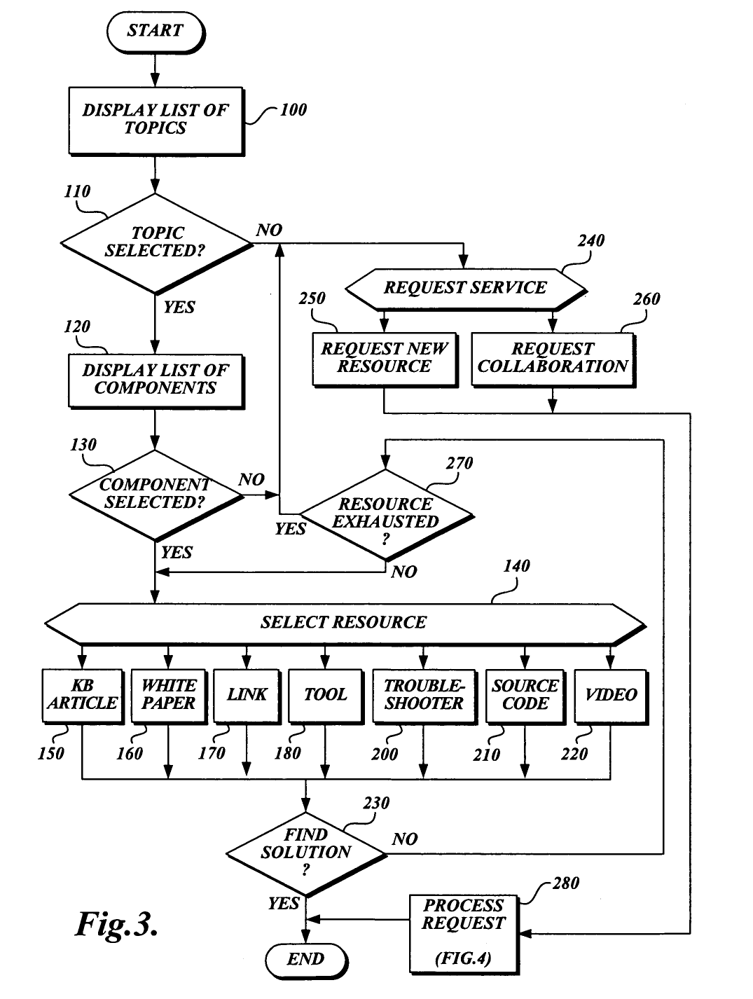

FIG. 3 is a flow diagram that illustrates an exemplary method for accessing the services provided by the information resources store 90 via the diagnostic portal 80. At block 100, a list of general problem topics is displayed for selection by a user. Preferably, the display is in the form of a Web page constructed by the diagnostic portal and sent to a user's computing device when the user logs onto a Web site that contain the diagnostic portal 80, commonly referred to as a “home page.” An example of such a Diagnostic Portal Home Page 101 is shown in FIG. 6. The exemplary Diagnostic Portal Home Page 101 shown in FIG. 6 includes a list of technical topics 103 on the right side. The illustrated lists includes the following topics: Administrative Tools, Application Compatibility, Base Operating System (OS), Clustering, Debugging, Directory Services, Distributed Systems, File Systems, Networking, Performance, Printing, Storage Area Networks (SAN), Storage Services, Video Training, and Virus-System Recovery. On the left side FIG. 6 includes an exemplary list of links to sources of information categorized by type, namely, Documents, Pictures, Lists, Discussions, and Surveys. Under the category of Documents are links to Diagnostic Library, Site Launch Information, Presentations, Request for Content, Templates and Forms, and Windows Discussion Groups are listed. Under the category of Lists are links to Related Links, Announcements, Contacts, Events, and Web Log are listed. Under the category of Discussions are links to Site Wish List, Ask the Admin, Common Questions and Answers, Provide RFC Form, Feedback or Suggestions, and Discuss Technical Questions are listed. Under the category of Surveys are links to Using Discussion Groups Search, and WDP July Visit Survey are listed. The Web browser page shown in FIG. 6 and the lists of topics and categories of links it presents are exemplary and should not be construed as limiting.

Below the list of technical topics 103 are links to various forms and requests, namely, Windows RFC Form, cannot submit the form ERROR, WDP Feature Request, ActiveX Control Issue Request and. Provide RFC Form Feedback Here. Below the links to forms and request is a link to a specific survey, namely, NT Spec Depot-Accessible only with CPR permission WDP July Visit Survey. Below the survey link is a link to a search for Windows Discussion Groups.

Located at the top of the Diagnostic Portal Home page 101 are conventional Web page tool bars. Since Web page tool bars are well known to those skilled in the art and do not form part of this invention, the tool bars illustrated in FIG. 6 are not described here.

If the user desires, topics on the home page can be expanded to reveal additional topics and/or subtopics. For example, “clicking” on the Diagnostic Library link in FIG. 6 access another Web page that includes an expanded topic list. See FIG. 7. In this example, in addition to the original topic list 103 (FIG. 6), topics such as Indexing Service, localization, Middleware-Runtime Services and others have been added to the original topic list. In a conventional manner, “clicking” or otherwise activating one of the topics opens a folder that contains a subtopic list. See FIG. 2 and the previous description. Clicking on a subtopic opens a folder that contains a list of subsubtopics, etc. As well known to those skilled in the art, the contents of the folders are presented to a user as a graphical user interface (GUI).

If, at block 110 in FIG. 3, a topic is selected, as previously described, a subtopic GUI is presented to the user. In the case of a computer support professional embodiment of the invention, as shown in FIG. 3, the subtopic page may contain a list of components. If a user selects a subtopic, a link to the resources associated with the subtopic (component) are enabled. As illustrated in FIG. 2, the links are to Knowledge Base (KB) articles 150, White Papers 160, Links to other information resources 170, Software Tools 180, Troubleshooters 200, Source Code files 210, and/or Video clips 220. While this list includes all of the subsubtopics and related linked items shown in FIG. 2 and described above, flattened for ease of illustration, the list should be construed as exemplary, not limiting. KB articles are a type of technical article which is available for Microsoft® Windows® operating systems and other Microsoft® operating systems and products. A KB article may include text, pictures, diagrams, and the like. Articles including text, pictures, diagrams, and the like may be used in place of, or in addition to, KB articles and so the use of the term KB articles should be construed as exemplary and not limiting. Selecting a particular item on the select resource list opens a Web page or otherwise enables a link to the related information.

As shown in FIG. 7 (left side top) subtopic information sources can be filtered in various ways. More specifically, filters under a heading titled Select a View can be employed to limit the selected resources displayed when a subtopic is selected. The available filters are: All Documents, Explorer View, Approve/Reject Items, and My Submissions. All Documents is, of course, no filter. Explorer View limits the documents in some preprogrammed way—documents generated after a particular date, for example. The selections Approve/Reject Items and My Submissions are available to subject experts. FIG. 7 also provides for certain desirable actions, specifically: Add to My Links, Alert Me, Explore to Spreadsheet, and Modify Settings and Columns. When enabled, these actions perform certain user desirable functions, such as adding a link to a user specific set of links, alerting a user when a new document is added to a subtopic, etc.

Returning to FIG. 3, if the first selected item in a resource category does not provide a solution, exiting the resource in essence, asks if a solution has been found (block 230). If no solution has been found, in the first selected item, the process cycles back to allow a user to select another item in the same resource category or another resource category until all resources have been exhausted (block 270). When all resources have been exhausted to the extent deemed necessary by a user, the user can navigate to a request service block. For example, the user may have negotiated through a sequence of troubleshooter actions at the end of which a dialog box may appear that asks if the problem has been resolved. If not resolved, the results of the troubleshooter sequence may be recorded if they have not been previously recorded during the troubleshooter process and the user sent to a request service form that the user is required to fill in to obtain access to other resources or expert assistance (described below). As shown in FIG. 3, a user can also request service if the initial list of topics, or the list of subtopics (components) does not identify a topic or subtopic in the user's problem area.

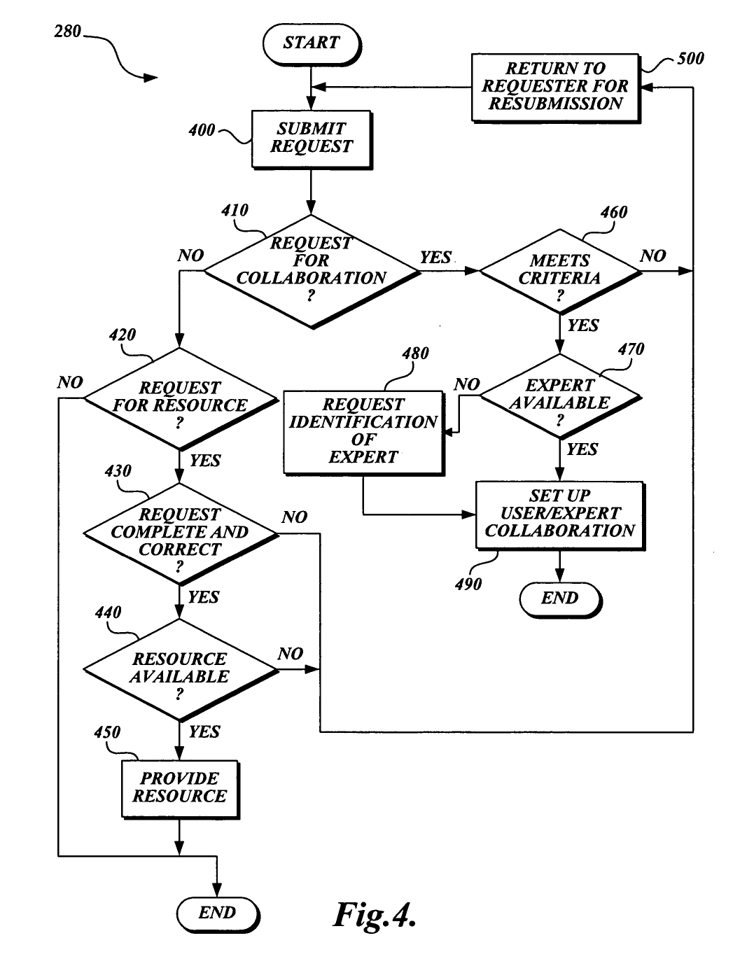

Regardless of how a user gets to the request service form, represented by block 240, filling in and submitting the form provides either access to additional informational resources 250, or an opportunity to collaborate with a subject expert 260. Requests for further service are processed at block 280. An exemplary process is illustrated in FIG. 4 and described in detail next.

FIG. 4 illustrates an exemplary process for processing a request for service (FIG. 3). Process Request 280 begins at block 400, when the request is submitted. At block 410, a request is examined (either manually or based on some predetermined criteria) to determine if the request is a request for collaboration with a subject expert, or if it is some other kind of request. If the request is a request for collaboration, the request is examined at block 460 (either manually or automatically based on some predetermined, criteria) to ensure that the submitted request meets certain criteria. Such criteria may include, but are not limited to, a complete description of the problem of concern to the submitter, a history of the activities performed in pursuit of a solution to the problem, information gathered concerning the problem thus far, and the submitter's contact information. If the criteria are met, subject experts considered qualified to address the type of problems submitted are contacted by a collaboration coordinator to determine their availability 470. The collaboration coordinator may be a person or an automatic program. If an expert is available, contact is established between the requester and the subject expert 490.

If the collaboration coordinator cannot identify or contact a suitable subject expert given the criteria in the original request, the collaboration coordinator may seek to identify an expert 480 using less stringent criteria. In cases where an exact match of expert to the subject of concern is not possible, an expert in a subject nearly matching the subject of concern may be identified.

If the criteria (block 460) are not met, the request is returned to the requester with directions to the requester describing how to complete the request 500.

It is likely, but not imperative, that the initial communication between the requester and the subject expert take place via electronic mail, e.g., email. Thus, an exemplary communication between a requester and subject expert may be managed by a software program or subroutine that communicates with the requester and the subject expert by sending email messages. The software component that manages the communication between a requester and a subject expert is referred to herein as the “collaboration coordinator.” The collaboration coordinator may send a message to a plurality of subject experts which meet certain criteria dictated by the content of the request, i.e., knowledge of the subject or subjects mentioned in the request. The collaboration coordinator may also, at or near the same time, send a message to the requester to inform the requester his or her request is being processed and include in the message a case number or some other reference to the original request.

If one or more subject experts reply to the message, the collaboration coordinator selects a subject expert from the group of replying subject experts. Criteria for this selection may be, but are not limited to, which subject expert replied first; which subject expert appears to be most qualified as determined by matching characteristics of the problem with the qualifications of the subject experts; which subject expert has the most time available; which subject expert is the least busy; and/or which subject expert has worked with the requester least (or most) recently. After the collaboration coordinator selects a subject expert, the collaboration coordinator sends a message to the subject expert containing a reference to, and/or information about, the original request. It is then incumbent upon the selected subject expert to contact the requester given the contact information available in the original request.

If, after a certain amount of time, the subject expert has not contacted the requester, the requester may send a message to the collaboration coordinator with a reference to the original request. The collaboration coordinator may then recontact the selected subject expert or select and contact another subject expert.

If, at block 410 in FIG. 4, it is determined that the request is not for collaboration with a subject expert, at block 420, a test is made to determine if the request is a request for a new information resource. If the request us not a request for a new information source, the request is rejected because the only two kinds of requests permitted in this exemplary embodiment are requests for collaboration and requests for new resources. It is to be understood that in other embodiments, other kinds of requests may be permitted. Thus, the restriction to two types of requests should be construed as exemplary and not limiting.

At block 430, the request for an additional (new) information resource is examined to ensure that the submitted request is complete and correct, e.g., meets certain criteria such as, but not limited to, the information resources used thus far and complete contact information. If the criteria are met, a search is done for an additional information resource, see block 440. If the criteria are not met, the request is returned to the requester with directions to the requester describing how to complete the request 500. If, at block 440, a new information resource fitting the requirements set forth in the resource request is found, the resource is returned (provided) to the requester 450. The determination of whether a new resource is available may be done automatically using predefined computer usable criteria, or manually by a “librarian.” If an information resource fitting the requirements set forth in the resource request is not found, the request is returned to the requester, possibly with a description of how the request may be better reconfigured to allow identification of a new information resource.

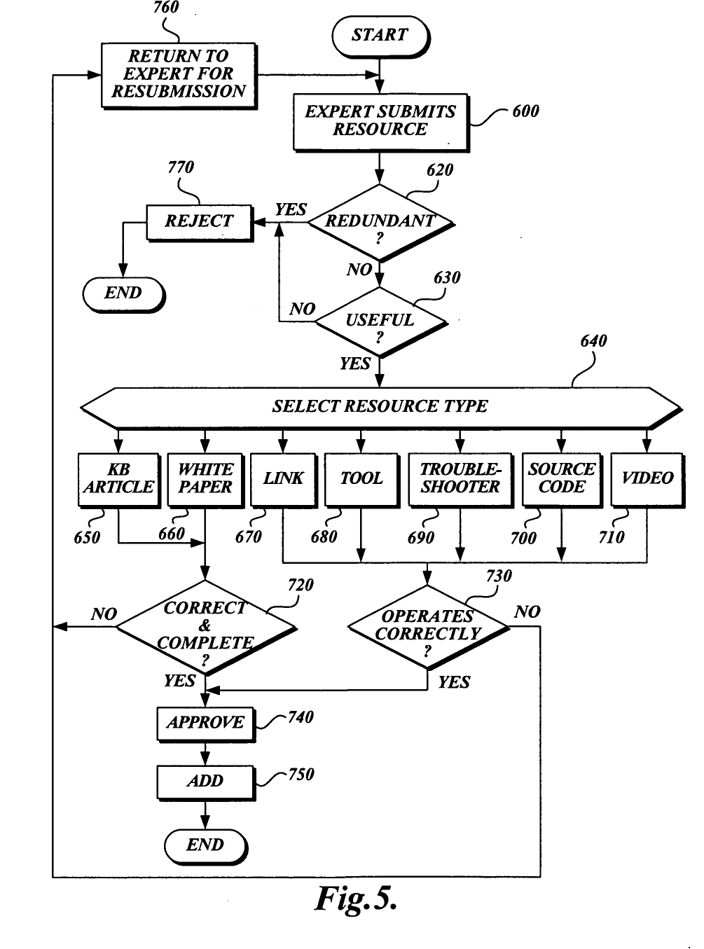

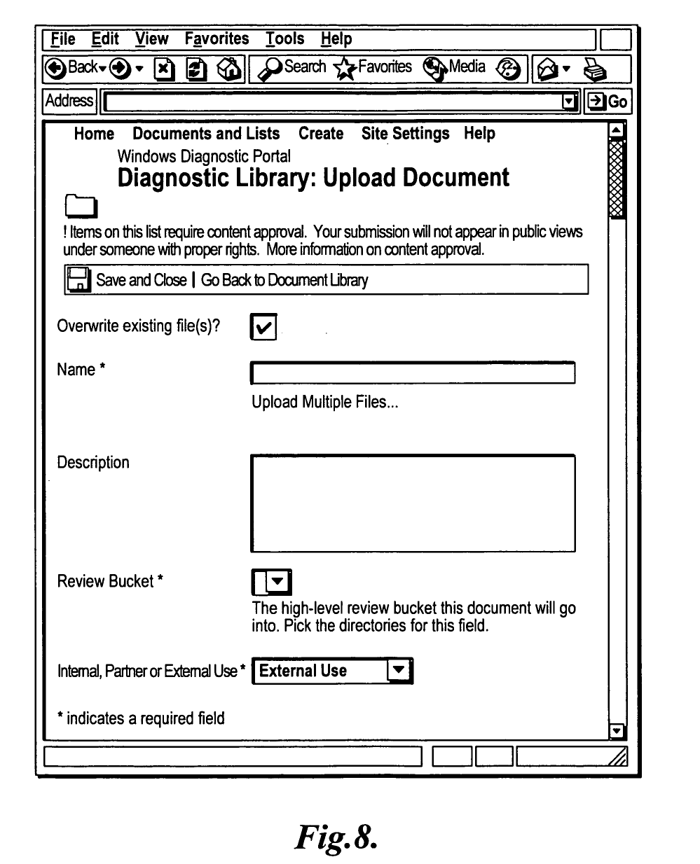

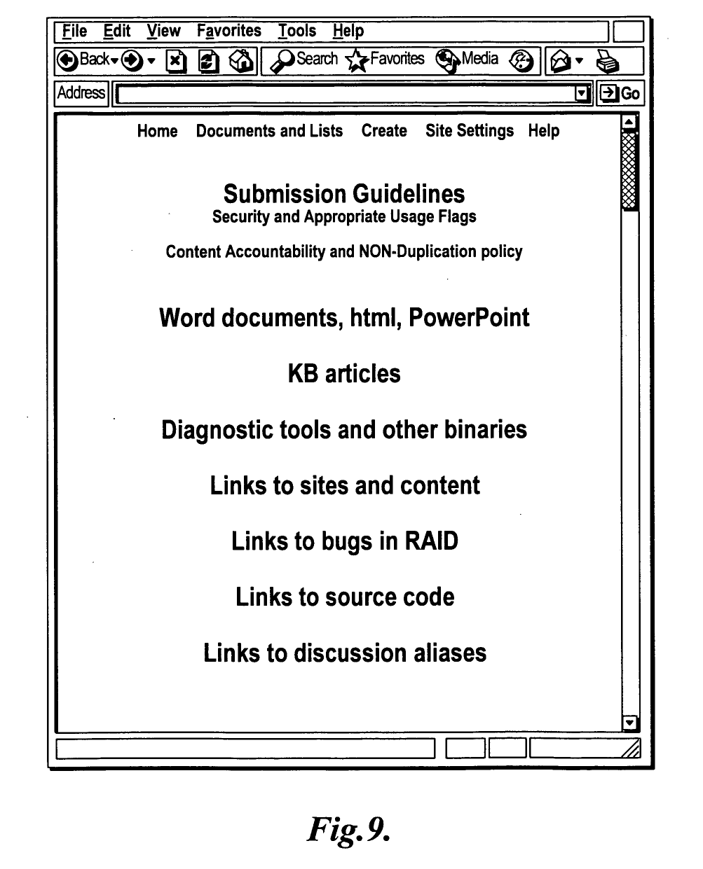

FIG. 5 illustrates the submission and approval process via which subject experts submit new information resources to be included in existing information resources and thereby become part of the information resources store 90. At block 600, the new information resource is submitted. An example of a page suitable for use by a subject expert to submit a new information resource is illustrated in FIG. 8. The FIG. 8 example includes data fields for the subject expert to enter the names of the file or files to be uploaded, and a description of the proposed new information resource. The first is designated a required field and the second is an optional field that is not necessary if an adequate description is contained in the file or files to be uploaded. FIG. 8 also requires that the submitting subject expert select a “review bucket” for the new information resource, e.g., the topic for which the information resource is intended, using a dropdown menu. FIG. 7 also requires that the information resource be designated as internal (available only to company employees) or external (available to employees and pre-qualified others that are not employees). In order to better use the submission page shown in FIG. 8, a submitting subject expert is allowed to access guidance information, an example of which is illustrated in FIG. 9. FIG. 9 includes links that allow the submitting subject expert to view information about submission guidelines, content accountability and non-duplication. FIG. 9 also provides links that allow a submitting subject expert to view formatting guidelines and other information about text documents, HTML documents, slide show documents, KB articles, diagnostic tools, and other types of binary files, links to sites and content, links to bugs in a bug database, links to source code, and links to discussion sites.

Returning to FIG. 5, at block 620, existing information resources are examined and compared to the submitted information resource to determine if the submitted information resource is redundant. This may be done automatically using a suitable algorithm, manually, or by an automatic/manual combination of steps. If the submitted information resource is essentially the same as one or more existing information resources, i.e., the submitted information resource is redundant by, for example, referencing an article that already is included in the information resources store, the submitted information resource is rejected 770. If the submitted information resource is found to be unique, e.g., not redundant, the resource is examined for usefulness 630. Usefulness may be determined manually or automatically using a predetermined algorithm, or determined using a manual/automatic combination of steps. Usefulness of the resource is determined by comparing characteristics of the resource to a set of criteria including, but not limited to relevance to existing topics and subtopics and applicability to the problem domain of the topic. If the submitted information resource is not useful, it is rejected 770. If the submitted information resource is useful, the submitted information resource is categorized according to resource type. Type can be determined manually or automatically using a predetermined algorithm, or determined using a manual/automatic combination of steps. As with resources referred to in FIGS. 2 and 3, useful information resources include, but are not limited to, Knowledge Base (KB) articles 650, white papers 660, network links to other information resources 670, software tools 680, troubleshooters 690, source code files 700, and/or video clips 710.

After a resource type is determined, if the type is in KB articles or white papers, the KB articles or white paper is examined for completeness and correctness 720. If KB article or white paper is incomplete, incorrect, or both, the resource is returned to the submitting expert with notes on how to reconfigure the resource to make it acceptable 760. If the form is a link, tool, troubleshooter, source code file, or video, the form is tested to determine operability 730. If found to be inoperable 730, the resource is returned 760 with notes describing the operation problem. The nature of such problems is specific to the form of the resource and examples for each form are described below. If the KB article or white paper is correct and complete, or if information resource is found to be operable, the submitted information resource is formally approved 740 and placed in, i.e., added to, one or more of the information databases 750.

Determining whether a KB article or white paper is correct and complete is determined by submitting the KB article or white paper to one or more submission review experts for review and approval. In contrast, operational problems associated with links, tools, troubleshooters, source code and videos may be partially or in some cases entirely evaluated using a software algorithm.

Link operational problems include, but are not limited to, a broken link, e.g., a link that does not point to a resource; a link which points to an out of date or incomplete resource; and a link which insufficiently indicates the nature of the resource to which it points and thereby possibly misleads a user.

Software tool operational problems include, but are not limited to, a tool which does not start; a tool which ceases to operate under normal conditions; and a tool which operates but does not complete the task or tasks for which it was intended or complete said tasks incorrectly and/or insufficiently.

Troubleshooter operational problems can be divided into four categories: general, text, pictorial, and software application. Troubleshooter general operational problems include, but are not limited to, a troubleshooter which does not address the problem or problems that for which it was intended; and a troubleshooter which is incomplete or incorrect. Troubleshooter text operational problems include, but are not limited to, the text troubleshooter which has numerous errors in spelling or grammar. Troubleshooter pictorial operational problems include, but are not limited to, pictorial troubleshooter in which the symbol set and/or visual language used is misleading and/or difficult to understand. Troubleshooter software application operational problems include, but are not limited to, a troubleshooter application which does not start; troubleshooter application which ceases to operate during normal use; and a troubleshooter application which operates but does not complete the troubleshooting path or paths.

Software code operational problems include, but are not limited to, source code which does not compile; source code which compiles with an unacceptable number of warnings; a source code which compiles but generates object code which does not operate on the platform for which it was intended; source code which generates usable object code but generates object code which does not fulfill the purpose for which it was intended; source code which does not conform to best practices for the language in which it was written; and source code which is incompletely or incorrectly commented.

Video operational problems include, but are not limited to, video which does not play or plays poorly; video which does not demonstrate the principles or procedures it was intended to demonstrate; and video which contains erroneous information which may or may not have to do with the main purpose of the video.

As will be readily appreciated that the invention provides a diagnostic portal that is relatively all encompassing with respect to subject of interest to the user. In the case of computer software professionals dedicated to diagnosing and solving problems in a specific computer area, such as operating systems, the diagnostic portal provides an organizational structure that allows computer software professionals to quickly and efficiently access multiple sources of information that may contain solutions to the particular problem being investigated. The diagnostic portal provides for content growth and includes a mechanism for enforcing quality and eliminating redundancy. In effect, the invention provides a one step portal for product support.

While various embodiments of the invention has been illustrated and described, it will be appreciated that various changes can be made therein, some of which have been described above, without departing from the spirit and scope of the invention as defined by the appended claims.

The embodiments of the invention in which an exclusive property or privilege is claimed are defined as follows:

1. A system for providing diagnostic and problem solving information comprising:
(a) an information resources store for storing diagnostic and problem solving information categorized in a hierarchical manner that includes topics and subtopics; and
(b) a diagnostic portal coupled to said information resources store that:
(i) in response to user input, searches said information store for diagnostic and problem solving information using topics and/or subtopics chosen by said user; and
(ii) in response to user request, processing requests for assistance beyond the information stored in said information store, said requests for assistance including requests for information not stored in said information store and requests for collaboration with an expert.

2. The system claimed in claim 1, wherein said topics and subtopics relate to computer system problem areas.

3. The system claimed in claim 2, wherein said topics and subtopics are divided into topics and subtopics familiar to computer support professionals.

4. The system claimed in claim 1, wherein said diagnostic portal also receives and evaluates submitted information to be added to said information store.

5. The system claimed in claim 4, wherein said submitted information is evaluated to determine if it is redundant and useful, information that is either redundant or not useful is rejected.

6. The system claimed in claim 5, wherein information that is both not redundant and useful is evaluated for correctness and completeness, or correct operation, depending on type.

7. A method of providing high quality diagnostic and problem solving information resources comprising:
compiling a resources information store containing diagnostic and problem solving information categorized according to topics and subtopics related to diagnosing and solving problems in a predetermined discipline;
in response to user input, searching said resources information store for diagnostic and problem solving information related to a particular problem area using said topic and subtopic categories; and
in response to user input, responding to requests for assistance outside the diagnostic and problem solving information contained in said resources information store, said request for assistance including resource information not contained in said information resource store and request for collaboration with an expert in said particular problem area.

8. The method of claim 7, wherein said topics and subtopics relate to problem areas encountered by computer support professionals.

9. The method of claim 7, including reviewing and evaluating diagnostic and problem solving information submitted to be added to said resources information store.

10. The method of claim 9, wherein said submitted diagnostic and problem solving information is sent to an expert to review for redundancy with other diagnostic and problem solving information stored in said resources information store and for usefulness.

11. The method of claim 10, wherein, if said submitted diagnostic and problem solving information is determined to not be redundant and useful by said expert determining if said submitted diagnostic and problem solving information is correct and complete, or operable, based on the category in which said diagnostic and problem solving information lies.

12. A computer readable medium containing instructions that, when executed, carries out the method of claim 7.

13. A computer readable medium containing instructions for creating an information resources store containing high quality diagnostic and problem solving information in a particular discipline, said instructions comprising:
in response to receiving diagnostic and problem solving information, forwarding said received diagnostic and problem solving information to an evaluator for determining if said received diagnostic and problem solving information is redundant and/or not useful;
if said received diagnostic and problem solving information is not redundant and is useful, determining if said received diagnostic and problem solving information is correct and complete, or operates successfully based on category; and
if said received diagnostic and problem solving information is correct and complete, or operates successfully, adding said received diagnostic and problem solving information to said information resources store.

14. The computer readable medium as claimed in claim 13, wherein said particular discipline is computer systems.

15. The computer readable medium as claimed in claim 14, wherein information stored in said information data store is categorized according to topic.

16. The computer readable medium as claimed in claim 15, wherein said topics are computer system topics.

17. The computer readable medium as claimed in claim 14, wherein said categories are chosen from the group consisting of KB articles, white papers, Troubleshooters and Source Code.

18. The computer readable medium as claimed in claim 17, wherein said categories also include Links, Tools, and Video.
